(19) United States
(12) Patent Application Publication
(10) Pub. No.: US 2017/0190606 A1
(43) Pub. Date: Jul. 6, 2017

(54) MOULD ASSEMBLY

(71) Applicant: GRAIL INVENTIONS (PTY) LTD., BELLVILLE (ZA)

(72) Inventor: Stanley William BENNETT, Durbanville (ZA)

(21) Appl. No.: 15/381,215

(22) Filed: Dec. 16, 2016

Related U.S. Application Data
(63) Continuation of application No. 14/000,530, filed on Oct. 30, 2013, now abandoned.

(30) Foreign Application Priority Data
Feb. 21, 2011 (ZA) 201101355

(51) Int. Cl. C03B 9/38; C03B 9/48; C03B 19/02; C03B 9/347

(52) U.S. Cl. CPC C03B 9/3875; C03B 9/347; C03B 9/48; C03B 19/02

(57) ABSTRACT

A method of forming a mould assembly (10) is provided. The method includes providing a mould body (12) defining a mould insert receiving zone (14). The method includes providing a mould insert (16), defining opposed sides (18, 20). One side (18) defines a mould cavity surface (21), against which an article is to be moulded, and the opposed side (20) defines a mould body seating arrangement (22) for seating the mould insert (16) in the mould insert receiving zone (14). The method further includes positioning the mould insert 16 in the mould insert receiving zone (14) of the mould body (12).

This application is a Continuation application of U.S. Ser. No. 14/000,530, filed Oct. 30, 2013, which is a National Stage of PCT/ZA2012/000009, filed Feb. 21, 2012, which claims priority under 35 U.S.C. §119 to South African Patent Application No. 2011/01355, filed Feb. 21, 2011, each hereby expressly incorporated by reference in its entirety.

### FIELD OF THE INVENTION

This invention relates to a mould assembly. In particular, the invention relates to a method of forming a mould assembly, to a mould assembly, to a mould assembly body and to a mould assembly insert.

### BACKGROUND OF THE INVENTION

Moulds are used in a variety of different industries to produce moulded articles. In many industries, such as the glass moulding industry, for example, the moulds used to mould glass articles are subject to relatively high temperatures. Typically, moulds used in the glass industry include two cast iron mould halves which are held together releasably to define an internal mould cavity. Cast iron is used because of its resistance to deformation at elevated temperatures and its wear resistant properties. Glass heated to a fluid state, or GOB, as it is colloquially referred to, is then introduced into the mould cavity and allowed to cool to form a glass article, such as, a glass bottle, for example. The mould halves are then separated from each other so as to enable the glass article to be removed. The mould halves are then again held together to define the mould cavity and the process is repeated to form another similarly shaped glass article.

The GOB when introduced into the mould cavity can be at a temperature of anywhere between 450° C. and 1050° C. The introduction of the GOB at these temperatures causes thermal shock to the mould. To compensate for the thermal shock, forced cooling is provided. This is achieved by passing a cooling fluid, such as, air, or the like, for example, through cooling passages defined by the mould halves. In addition, the mould halves are robust and are formed from a relatively large amount of material, to accommodate the cooling passages as well as to cope with the temperature shock. Typically, these cooling passages are in the form of straight bores extending generally parallel relative to one another in spaced apart relationship surrounding the mould cavity.

It has been found that, the current moulds used in industries, such as the glass moulding industry, for example, give rise to certain disadvantages. Firstly, internal surfaces of the mould halves are subjected to wear. A carbon solution is applied periodically to the surfaces to inhibit an outer surface of the glass article from being rough as a result of such surface wear. The carbon solution used is carcinogenic. Accordingly, the use of such a carbon solution is detrimental to people's health. Secondly, should it be desired to apply moulded shapes, such as, decals, trade-marks, icons, or the like, for example, to a surface of a glass article, there are limitations to doing so because of the characteristics of cast iron. Thirdly, the internal surface, of the mould halves which together define the mould cavity, are periodically polished to even wear on the surfaces and to remove carbon build up. This interrupts production resulting in loss of production. Fourthly, the mould cavity grows due to wear. Accordingly, when the mould is used to form glass articles, such as bottles, for example, a greater amount of GOB has to be used to maintain consistent internal volumes of the bottles. Fifthly, where the surfaces defining the mould cavity are irregularly shaped to produce irregularly shaped glass articles, such as bottles defining neck portions, for example, the glass articles are subjected to irregular cooling since the distance between the mould surfaces and the cooling passages vary because of such an irregular shape. This can lead to weak areas of the glass article and breakage during production.

It is an object of the invention to provide a mould assembly arranged at least to inhibit, or reduce, the disadvantages referred to above.

### SUMMARY OF THE INVENTION

According to a first aspect of the invention, there is provided a method of forming a mould assembly, the method including:

providing a mould body defining a mould insert receiving zone;

providing a mould insert defining opposed sides, one side of which defines a mould cavity surface against which an article is to be moulded, the opposed side of which defines a mold body seating arrangement for seating the mould insert in the mould insert receiving zone; and

positioning the mould insert in the mould insert receiving zone of the mould body.

The mould body may be in the form of a plurality of mould body parts, the method including locating the mould body parts together.

The mould insert may be defined by a plurality of mould insert parts, the method including positioning the mould insert parts in the mould insert receiving zones defined by each mould body part prior to locating the mould body parts together. The mould body and the mould insert may be arranged to define cooling passages, positioning the mould insert in the mould insert receiving zone of the mould body then including positioning the mould insert in the mould insert receiving zone of the mould body to define cooling passages extending along the mould cavity surface.

The mould cavity surface may be irregularly shaped, positioning the mould insert in the mould insert receiving zone of the mould body to define cooling passages extending along the mould cavity surface, then including positioning the mould insert in the mould insert receiving zone of the mould body to define cooling passages which extend generally equidistantly from the mould cavity surface.

The mould body and the mould insert may be arranged to define the cooling passages at an interface between the mould insert and the mould body, positioning the mould insert in the mould insert receiving zone of the mould body to define cooling passages extending along the mould cavity surface then including positioning the mould insert in the mould insert receiving zone such that each cooling passage is defined partially by the mould body and partially by the mould insert.

The mould body may define a mould body insert receiving surface between which the mould body insert receiving zone is defined, the method including positioning the mould insert in the mould insert receiving zone against the mould body insert receiving surface.

In one embodiment, the mould insert defines spaced apart rib formations defining extreme end portions, the extreme end portions being arranged to seat against the mould body insert receiving surface in the mould body insert receiving zone so as to define the cooling passages between the mould body insert receiving surface and the spaced apart rib formations.

The mould body insert receiving surface may extend regularly along the mould body and the extreme end portions of the spaced apart rib formations may extend regularly along the mould body insert, positioning the mould insert in the mould insert receiving zone against mould body insert receiving surface then including positioning the extreme end portions of the spaced apart rib formations longitudinally to abut against the mould body insert receiving surface.

The mould body insert receiving surface may extend irregularly along the mould body and the extreme end portions of the spaced apart rib formations may extend irregularly along the mould body insert, positioning the mould insert in the mould insert receiving zone against the mould body insert receiving surface then including is positioning the extreme end portions of the spaced apart rib formations longitudinally to abut against the mould body insert receiving surface.

In another embodiment, the mould body defines spaced apart rib formations defining extreme end portions, the extreme end portions being arranged to seat against the mould body insert in the mould insert receiving zone so as to define the cooling passages between the mould body insert and the spaced apart rib formations.

The extreme end portions of the spaced apart rib formations may extend irregularly along the mould body and the mould body insert may define an irregularly extending outer surface, positioning the mould insert in the mould insert receiving zone against the mould body then including positioning the extreme end portions of the spaced apart rib formations longitudinally to abut against the irregularly extending outer surface of the mould body insert.

The mould body insert may define opposed flange formations and the mould body may define opposed flange seat formations, positioning the mould insert in the mould insert receiving zone of the mould body then including seating the opposed flange formations in the opposed flange seat formations.

The mould body insert may define securing means for securing the opposed flange formations in the opposed flange seat formations, the method including securing the opposed flange formations in the opposed flange seat formations.

The securing means may define apertures and the mould body may define internally screw-threaded holes, securing the opposed flange formations in the opposed flange seat formations then including screw threadedly securing screw-threaded fasteners through the apertures in the flange formations into screw-threaded engagement with the internally screw-threaded holes in the mould body.

According to another aspect of the invention, there is provided a mould assembly, the mould assembly including:

a mould body defining a mould insert receiving zone; and

a mould insert defining opposed sides, one side of which defines a mould cavity surface against which an article is to be moulded, the opposed side of which defines a mould body seating arrangement for seating the mould insert in the mould insert receiving zone, the mould insert being positioned in the mould insert receiving zone of the mould body.

The mould body may be in the form of a plurality of mould body parts, the plurality of mould body parts being arranged to be located together to define the mould body.

The mould insert may be defined by a plurality of mould insert parts, the plurality of mould insert parts being arranged to be positioned together to define the mould cavity when positioned in the mould body parts and the mould body parts are located together.

At least one of the mould body and the mould insert may be arranged to define cooling passages.

Typically, the mould body and the mould insert together define the cooling passages.

The mould cavity surface may be irregularly shaped. The cooling passages may extend generally equidistantly from the mould cavity surface.

The mould body and the mould insert may be arranged to define the cooling passages at an interface between the mould insert and the mould body such that each cooling passage is defined partially by the mould body and partially by the mould insert.

The mould body may define a mould body insert receiving surface between which the mould body insert receiving zone is defined, the mould insert being positioned in the mould insert receiving zone against the mould body insert receiving surface.

In one embodiment, the mould insert defines spaced apart rib formations defining extreme end portions, the extreme end portions being arranged to seat against the mould body insert receiving surface in the mould body insert receiving zone so as to define the cooling passages between the mould body insert receiving surface and the spaced apart rib formations.

The mould body insert receiving surface may extend regularly along the mould body and the extreme end portions of the spaced apart rib formations may extend regularly along the mould body insert the spaced apart rib formations being positioned longitudinally to abut against the mould body insert receiving surface.

The mould body insert receiving surface may extend irregularly along the mould body and the extreme end portions of the spaced apart rib formations may extend irregularly along the mould body insert the spaced apart rib formations being positioned longitudinally to abut against the mould body insert receiving surface.

In another embodiment, the mould body defines spaced apart rib formations defining extreme end portions, the extreme end portions being arranged to seat against the mould body insert in the mould insert receiving zone so as to define the cooling passages between the mould body insert and the spaced apart rib formations.

The extreme end portions of the spaced apart rib formations may extend irregularly along the mould body and the mould body insert may define an irregularly extending outer surface, the mould insert being positioned in the mould insert receiving zone longitudinally to abut against the extreme end portions of the rib formations.

The mould body insert may define opposed flange formations and the mould body may define opposed flange seat formations, the opposed flange formations being seated in the opposed flange seat formations.

The mould body insert may define securing means for securing the opposed flange formations in the opposed flange seat formations.

The securing means may define apertures and the mould body may define internally screw-threaded holes, the opposed flange formations being secured in the opposed flange seat formations by screw-threaded fasteners extending through the apertures into screw-threaded engagement with the internally screw-threaded holes in the mould body.

According to another aspect of the invention, there is provided a mould assembly including a mould body as described above.

According to another aspect of the invention, there is provided a mould assembly including a mould insert as described above.

### BRIEF DESCRIPTION OF THE DRAWINGS

Embodiments of the invention will now be described, by way of example, with reference to the accompanying diagrammatic drawings, in which:

FIG. 1 shows a schematic three dimensional view of a mould body part in accordance with an embodiment of the invention;

FIG. 2 shows a schematic three dimensional view of a mould insert part for use with the mould body part as shown in FIG. 1 of the drawings;

FIG. 3 shows schematic plan view of a mould body part and a mould insert part, in accordance with a similar embodiment of the invention;

FIG. 3A shows a schematic sectional exploded side view along arrows I in FIG. 3 of the drawings;

FIG. 3B shows schematic end view along arrows II in FIG. 3 of the drawings;

FIG. 4 shows a schematic plan view of a mould body part and a mould insert part, in accordance with another embodiment of the invention;

FIG. 4A shows a schematic sectional exploded side view along arrows III in FIG. 4 of the drawings;

FIG. 4B shows a schematic end view along arrows IV in FIG. 4 of the drawings;

FIG. 5 shows a schematic plan view of a mould body part and a mould insert part, in accordance with a further embodiment of the invention;

FIG. 5A shows a schematic sectional exploded side view along arrows V in FIG. 5 of the drawings; and

FIG. 5B shows a schematic end view along arrows VI in FIG. 5 of the drawings.

### DETAILED DESCRIPTION OF PREFERRED EMBODIMENTS

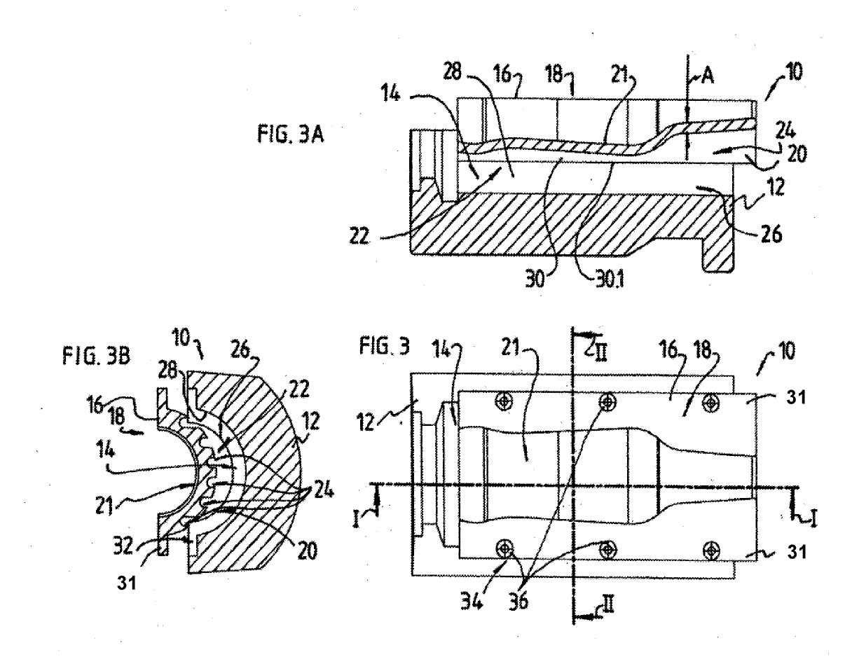

Referring to FIGS. 1, 3, 3A and 3B of the drawings, part of a mould assembly in accordance with an embodiment of the invention, is generally indicated by reference numeral 10. It will be appreciated that the mould assembly includes two of the mould assembly parts 10 positioned together to define an internal moulding cavity.

In the embodiments shown in the drawings, the mould assembly is arranged for moulding glass bottles. However, it will be appreciated that the scope of the invention is not limited to the moulding of glass bottles only, but extends to moulding other glass articles and moulding articles in general.

The part of the mould assembly 10 includes a mould body part 12. The mould body part 12 defines a mould insert receiving zone 14. In addition, the part of the mould assembly 10 includes a mould insert 16. The mould insert 16 defines opposed sides 18, 20. One side 18 defines a mould cavity surface 21 against which an article is to be moulded. The opposed side 20 defines a mould body seating arrangement 22 for seating the mould insert 16 in the mould insert receiving zone 14 so as to be positioned in the mould insert receiving zone 14 of the mould body 12.

The mould body can be in the form of a plurality of mould body parts. In the embodiments shown in the drawings, the mould body is made up of two similar mould body halves, only one of which is shown in each of the drawings. It will be appreciated that the mould body can be made up of more than two body parts, for example. The mould body parts are arranged to be located together to define the mould body.

The mould insert can be defined by a plurality of mould insert parts. The plurality of mould insert parts are then arranged to be positioned together to define the mould cavity when positioned in the mould body parts and the mould body parts are located together. Although, in the drawings, the mould insert is made up of two similar mould insert halves, only one of which is shown in each of the drawings, it will be appreciated that the mould insert can be made up of more than two mould insert parts, for example.

At least one of the mould body and the mould insert is arranged to define cooling passages. The cooling passages are positioned generally equidistantly from the mould cavity surface. It has been found that by providing cooling passages to extend generally equidistantly from the mould cavity surface, a more uniform cooling is provided during moulding of an article.

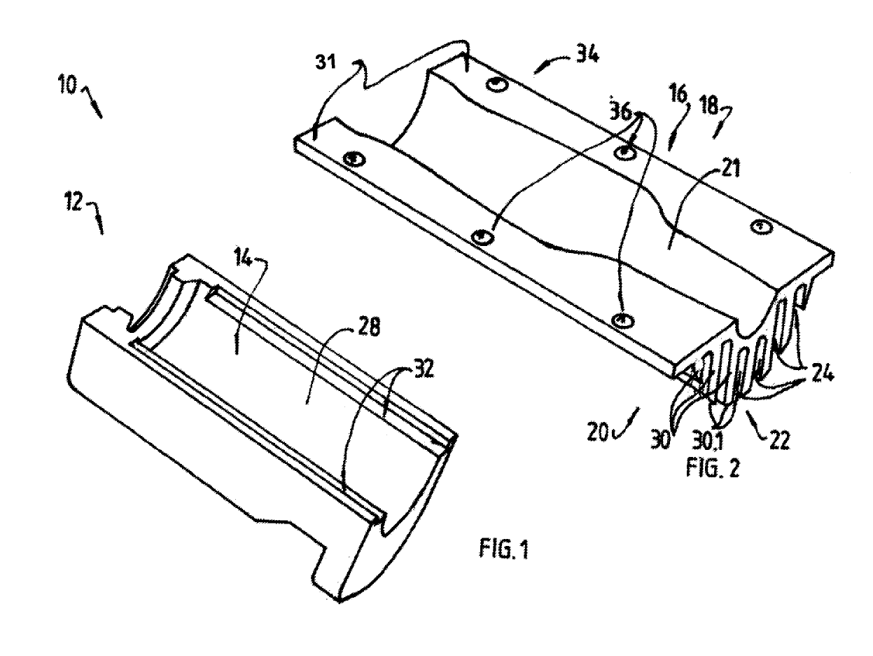

In FIGS. 1 to 3 of the drawings, the mould body part 12 and the mould insert 16 together define cooling passages 24. The mould cavity surface 21 is irregularly shaped, for example, where a bottle is to be moulded from glass. As can best be seen with reference to FIG. 3A of the drawings, the cooling passages 24 extend generally equidistantly from the mould cavity surface 21, as indicated by arrow A.

The mould body part 12 and the mould insert part 16 are arranged to define the cooling passages 24 at an interface 26 between the mould insert part 16 and the mould body part 12. Accordingly, each cooling passage 24 is defined partially by the mould body part 12 and partially by the mould insert part 16.

The mould body part 12 defines a mould insert receiving surface 28 between which the mould insert receiving zone 14 is defined. In use, the mould insert part 16 is positioned in the mould insert receiving zone 14 against the mould body insert receiving surface 28.

The mould insert part 16 defines spaced apart rib formations 30 defining extreme end portions 30.1. The extreme end portions 30.1 are arranged to seat against the mould body insert receiving surface 28 in the mould body insert receiving zone 14 so as to define the cooling passages 24 between the mould body insert receiving surface 28 and the spaced apart rib formations 30. The extreme end portions 30.1 of the rib formations 30 define the mould body seating arrangement 22.

The extreme end portions 30.1 of the spaced apart rib formations 30 extend regularly along the mould body insert 16. The spaced apart rib formations 30 are positioned longitudinally to abut against the mould body insert receiving surface 28.

The mould body insert part 16 defines opposed flange formations 31 and the mould body part 12 defines opposed flange seat formations 32. The opposed flange formations 31 are seated in the opposed flange seat formations 32 to locate the mould body insert part 16 on the mould body part 12.

The mould body insert part 16 defines securing means, generally indicated by reference numeral 34, for securing the opposed flange formations 30 in the opposed flange seat formations 32. The securing means 34 can define apertures 36 and the mould body part 12 can define internally screw-threaded holes. The opposed flange formations 30 can then be secured in the opposed flange seat formations 32 by screw-threaded fasteners extending through the apertures 36 into screw-threaded engagement with the internally screw-threaded holes in the mould body part 12.

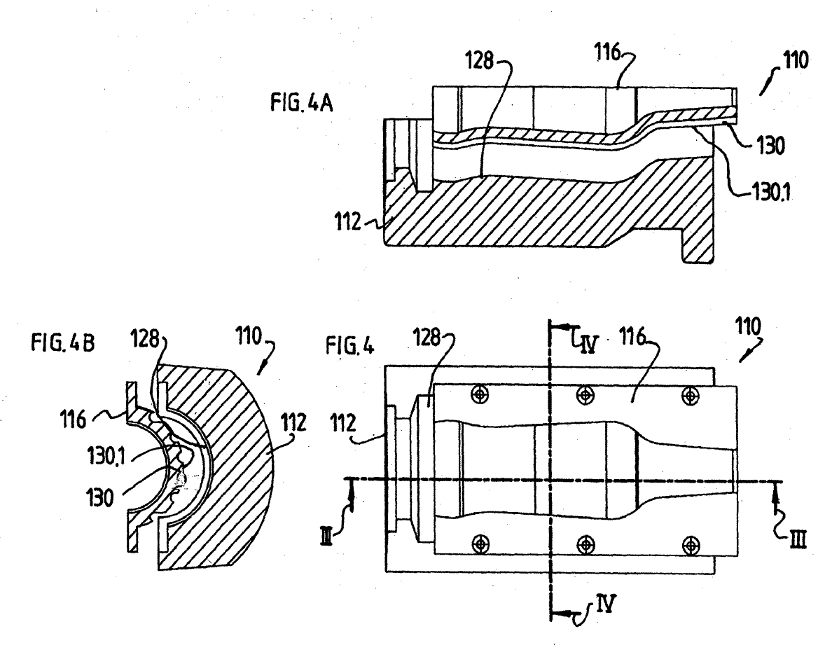

Referring now to FIGS. 4, 4A and 4B of the drawings, in which like reference numerals have been used to designate similar parts, or features, unless otherwise stated, part of a mould assembly in accordance with another embodiment of the invention, is generally indicated by reference numeral 110. The part of the mould assembly 110 is similar to the part of the mould assembly 10, save that the mould body insert receiving surface 128 extends irregularly along the mould body part 112.

Accordingly, the extreme end portions 130.1 of the spaced apart rib formations 130 extend irregularly along the mould body insert part 116 so as longitudinally to abut against the mould body insert receiving surface 128.

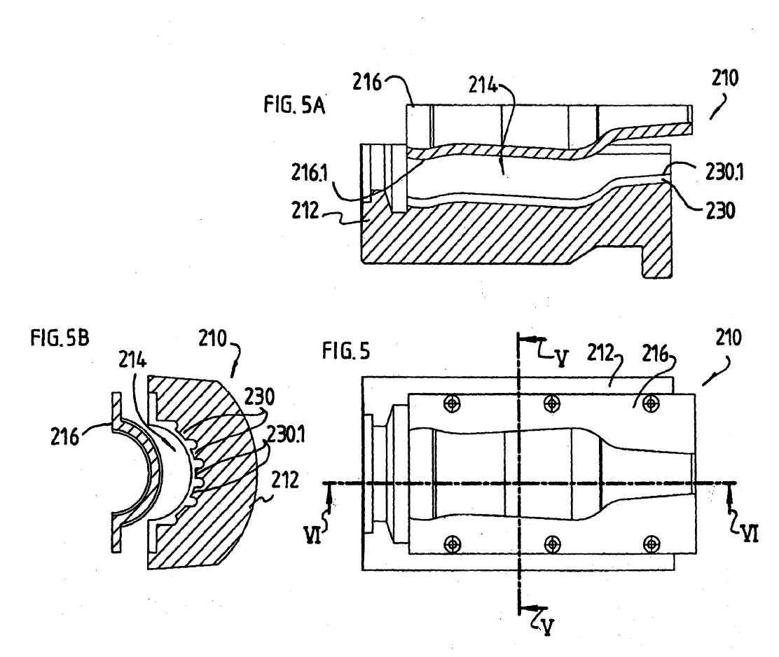

Referring now to FIGS. 5, 5A and 5B of the drawings, in which like reference numerals have been used to designate similar parts, or features, unless otherwise stated, part of a mould assembly in accordance with yet another embodiment of the invention, is generally indicated by reference numeral 210. The mould body part 212 defines the spaced apart rib formations 230 defining extreme end portions 230.1. The extreme end portions 230.1 are arranged to seat against the mould body insert part 216 in the mould insert receiving zone 214, so as to define the cooling passages 224 between the mould body insert part 216 and the spaced apart rib formations 230.

The extreme end portions 230.1 of the spaced apart rib formations 230 extend irregularly along the mould body part 212. The mould body insert part 216 defines an irregularly extending outer surface 216.1. The mould insert part 216 is, in use, positioned in the mould insert receiving zone 214 longitudinally to abut against the irregularly extending extreme end portions 230.1 of the spaced apart rib formations 230.

By providing a mould cavity insert, or mould body insert part, as described above, the mould cavity insert can simply be replaced upon becoming worn, or no longer usable. In this way, replacing an entire mould body would not be required. In addition, by providing cooling passages which extend generally equidistantly from an irregular mould cavity surface, a more uniform cooling is provided to an article when moulded. The mould cavity insert can include materials such as, beryllium, nickel, boron and/or manganese, for example.

1. A method of forming a mould assembly, the method including:
providing a mould body defining a mould insert receiving zone;
providing a mould insert defining opposed sides, one side of which defines a mould cavity surface against which an article is to be moulded, the opposed side of which defines a mould body seating arrangement for seating the mould insert in the mould insert receiving zone; and
positioning the mould insert in the mould insert receiving zone of the mould body.

2-27. (canceled)
